(19) United States
(12) Patent Application Publication
(10) Pub. No.: US 2016/0185571 A1
(43) Pub. Date: Jun. 30, 2016

(54) HAZARD HIGHLIGHTING METHOD AND APPARATUS

(71) Applicants: John Virgurs CURZON, Eynsham (GB); Peter COLLINS, Eynsham (GB)

(72) Inventors: John Virgurs CURZON, Eynsham (GB); Peter COLLINS, Eynsham (GB)

(73) Assignee: AIRDRI LIMITED, Eynsham, Oxford (GB)

(21) Appl. No.: 14/129,969

(22) PCT Filed: Jun. 28, 2011
(86) PCT No.: PCT/GB2011/051224

§ 371 Date: Oct. 21, 2014

(51) Int. Cl. B66B 5/02; G08B 5/36; B66B 13/30

(52) U.S. Cl. CPC B66B 5/02; B66B 13/30; G08B 5/36

(57) ABSTRACT

A method of hazard highlighting for drawing visual attention to the alignment of first and second members, the first member having a first plane working surface and a first working edge; the second member having a second plane working surface and a second working edge; the first and second working edges being separated by a working clearance; the first and second members being displaceable relative to one another wherein, in a first operating configuration, the first and second plane working surfaces lie in a common plane with the first and second working edges juxtaposed with the working clearances separated by a minimum distance; and, in a second configuration, the first and second plane working surfaces do not lie in the common plane and the first and second working edges are displaced from one another to a greater or lesser degree with the working edges being separated by a distance greater than minimum; the method including the step of projecting a light ray or pattern from a location associated with the first working surface towards the second working surface and across the working clearance so that to an observer situated above the first and second working surfaces and in the first configuration the projected light ray or pattern appears as a continuous image extending across both working surfaces; and in the second configuration the projected light ray or pattern becomes an image visually interrupted in the vicinity of the working clearance by comparison with the continuous image of the first configuration.

### TECHNICAL FIELD

The present invention relates to hazard highlighting. It is particularly concerned with hazards arising in connection with differences between two levels which create a potential risk for trip and fall incidents.

### BACKGROUND ART

In relation to elevators (otherwise known as lifts) trip and fall accidents account for a substantial proportion of personal injuries. The most significant trip hazard arises when the level between elevator car floor and a floor outside the elevator at which the car is standing with an open door differs by an amount outside a predetermined working tolerance. The difference arises as a result of a failure within the elevator's levelling system and results in a step between the levels with the elevator door open. Failure to recognise the level difference when walking into or out of the car can result in tripping and/or falling.

Among the factors that can contribute to a hazard with an elevator car and outside floor with out-of-level alignment are the following. The threshold areas between car and outside floor involve few interesting or distracting features and consequently the glance of a passenger is not usually detained in the threshold areas but is directed to some other feature. Threshold sills at the elevator entrance are often fitted with edging of bright metal extrusions. Consequently the interface between neighbouring surfaces of elevator entrance sill and the adjacent floor edge are typically reflective which can cause an observer who briefly glances in the direction of the interface to concentrate on a light source rather than the neighbouring surfaces where a level difference can exist. Ambient illumination in an elevator car, and a landing onto which it opens, is generally from light sources above the sill. This can minimise apparent level differences between sill and edge. In bad cases the elevator lighting can be brighter than the landing making the landing a shadowed location.

The relative positions of the eyes of a passenger and the threshold area are such that if the passenger is gazing forward in expectation of the door opening the threshold is unlikely to be visible or is at best at the periphery of vision. Any difference in level will not be apparent until the doors are at least partially open so that the probability of noticing a level difference hazard is limited by the time available and distraction arising from the imminent opportunity to move.

### DISCLOSURE OF INVENTION

According to a first aspect of the present invention there is provided a method of hazard highlighting for drawing visual attention to the alignment of first and second members, the first member having a first plane working surface and a first working edge; the second member having a second plane working surface and a second working edge; the first and second working edges being separated by a working clearance; the first and second members being displaceable relative to one another wherein, in a first operating configuration, the first and second plane working surfaces lie in a common plane with the first and second working edges juxtaposed with the working clearances separated by a minimum distance; and, in a second configuration, the first and second plane working surfaces do not lie in the common plane and the first and second working edges are displaced from one another to a greater or lesser degree with the working edges being separated by a distance greater than minimum; the method including the step of projecting a light ray or pattern from a location associated with the first working surface towards the second working surface and across the working clearance so that to an observer situated above the first and second working surfaces and in the first configuration the projected light ray or pattern appears as a continuous image extending across both working surfaces; and in the second configuration the projected light ray or pattern becomes an image visually interrupted in the vicinity of the working clearance by comparison with the continuous image of the first configuration.

According to a first preferred version of the first aspect of the present invention there the first member is a floor of an elevator car and the second member is a floor outside the elevator car to enable people and/or goods to pass between the elevator car and the floor outside the elevator car; with the first and second members in their second configuration with a difference in level between the floor of the elevator car and the floor outside the elevator car a warning signal is generated, at least for a passenger in the elevator, as to the significance of the differences between the continuous and discontinuous images.

According to a second aspect of the present invention there is provided apparatus for drawing visual attention to the alignment of first and second members, the first member having a first plane working surface and a first working edge; the second member having a second plane working surface and a second working edge; the first and second working edges being separated by a working clearance; the first and second members being displaceable relative to one another wherein, in a first operating configuration, the first and second plane working surfaces lie in a common plane with the first and second working edges juxtaposed with the working clearances separated by a minimum distance; and, in a second configuration, the first and second plane working surfaces do not lie in the common plane and the first and second working edges are displaced from one another to a greater or lesser degree with the working edges being separated by a distance greater than minimum characterised by at least one light ray or pattern projecting means located by way of the first member and relative to the first working surface whereby the or each means causes a light ray or pattern to be projected towards the second working surface by way of the working clearance so that with the members in their first configuration the projected light ray or pattern appears as a continuous image extending across both the first and second working surfaces; and in the second configuration the projected light ray or pattern becomes an image visually interrupted in the vicinity of the working clearance by comparison with the continuous image. Typically the relative movement of members is vertical.

According to a third preferred version of the present invention there is provided an elevator car equipped with apparatus according to the second aspect or the first preferred version thereof.

According to a fourth preferred version of the third aspect of the present invention there is provided an elevator car wherein the first member is separated from the second by a slidable barrier operable between an open position where the barrier enables the passage of people or items from the first working surface to the second and a closed position where the barrier serves to prevent such passage characterised in that the or at least one light projecting means is incorporated in the slidable barrier to provide for the or each projected light ray or pattern to be projected from the first member towards the second member at least with the barrier in the open position.

The invention is particularly applicable to an installation utilising an elevator (otherwise known as a lift). If a floor of the elevator is taken as embodying the first member of the present invention and a floor region outside the elevator embodies the second member then, with the elevator door open for passenger entry and exit to the floor region, if the two members are in their first working configuration the two working surfaces of the two members lie in a common plane with their neighbouring edges at their closest. With the vertical separation of the lift floor and the floor region within acceptable limits then the fact is made clear by a continuous light beam across the interface between lift floor and nearby floor region. In the event the vertical separation lies outside acceptable limits then the continuous light beam becomes discontinuous so providing a visual indication that extra care should be taken by lift users entering or leaving the car in the region of the interface.

The term ‘light beam’ is used as a generic description for a projected light which can take a variety of appearances such as plain or patterned and can have parallel, converging or diverging sides.

### BRIEF DESCRIPTION OF DRAWINGS

Two exemplary embodiments of the invention will now be described with reference to the accompanying diagrams of an elevator system in various configurations.

### First Embodiment

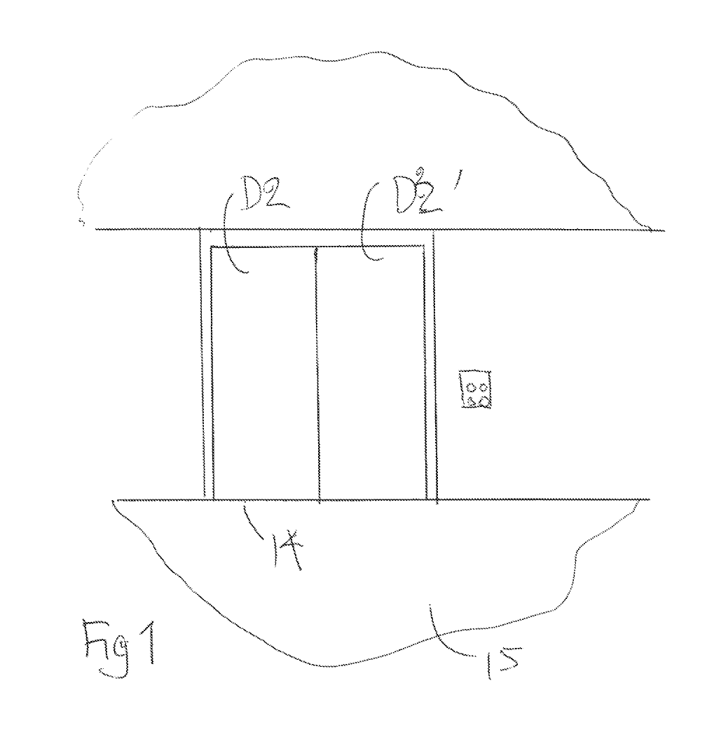

FIG. 1 is a front elevation of a lift installation on a floor of a building with car and floor doors closed;

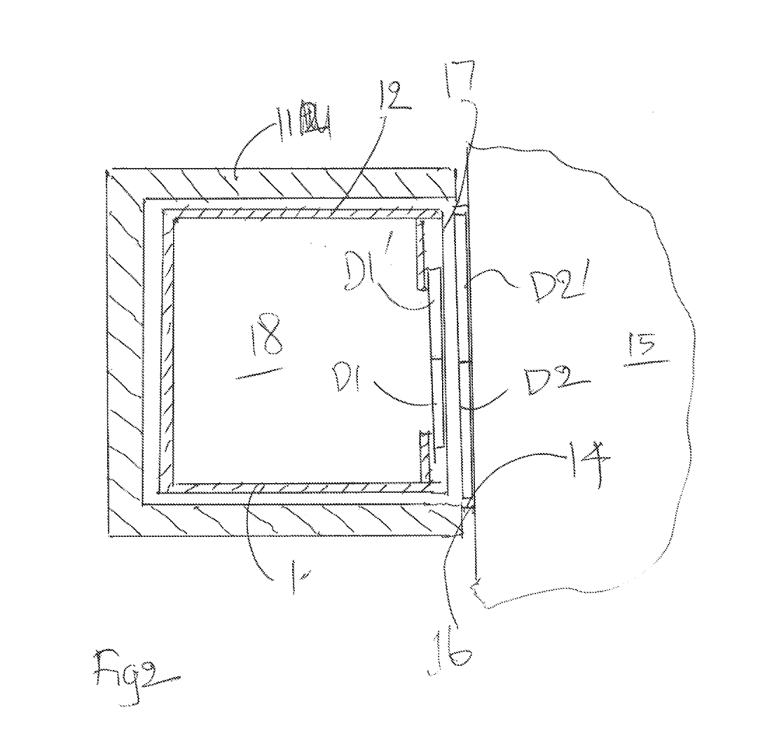

FIG. 2 is a plan view of the lift installation of FIG. 1;

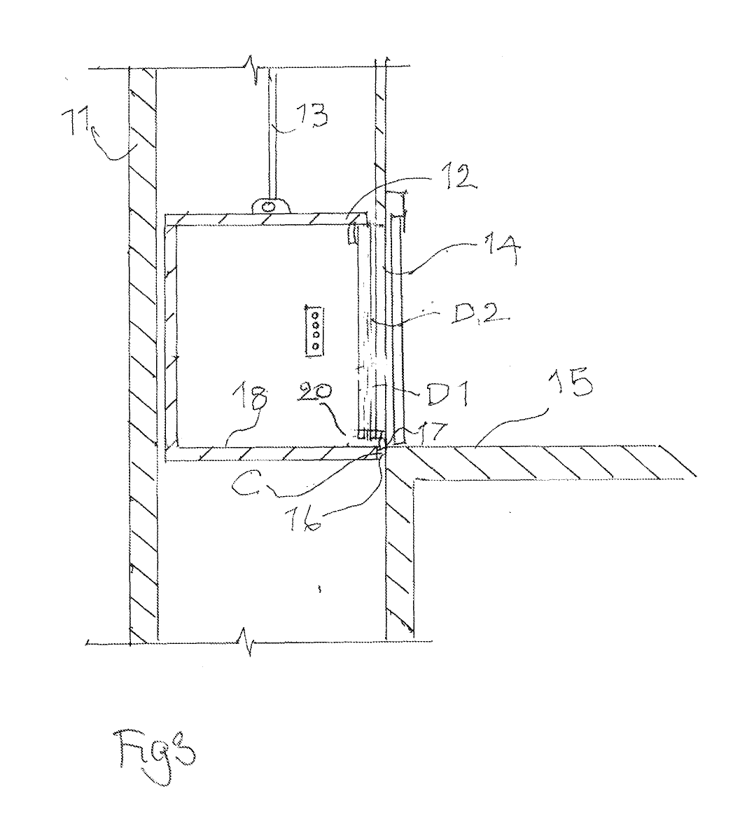

FIG. 3 is a side elevation of the installation of FIGS. 1 and 2 with a lift car in a first position relative to the lift shaft;

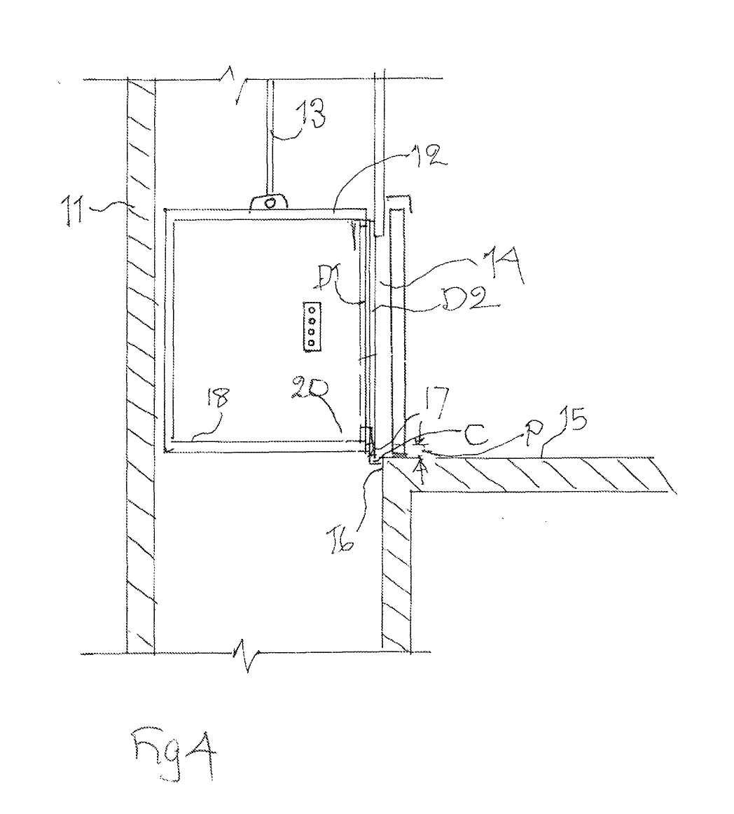

FIG. 4 is a side elevation of the installation of FIGS. 1 and 2 with the lift car in a second position relative to the shaft; and

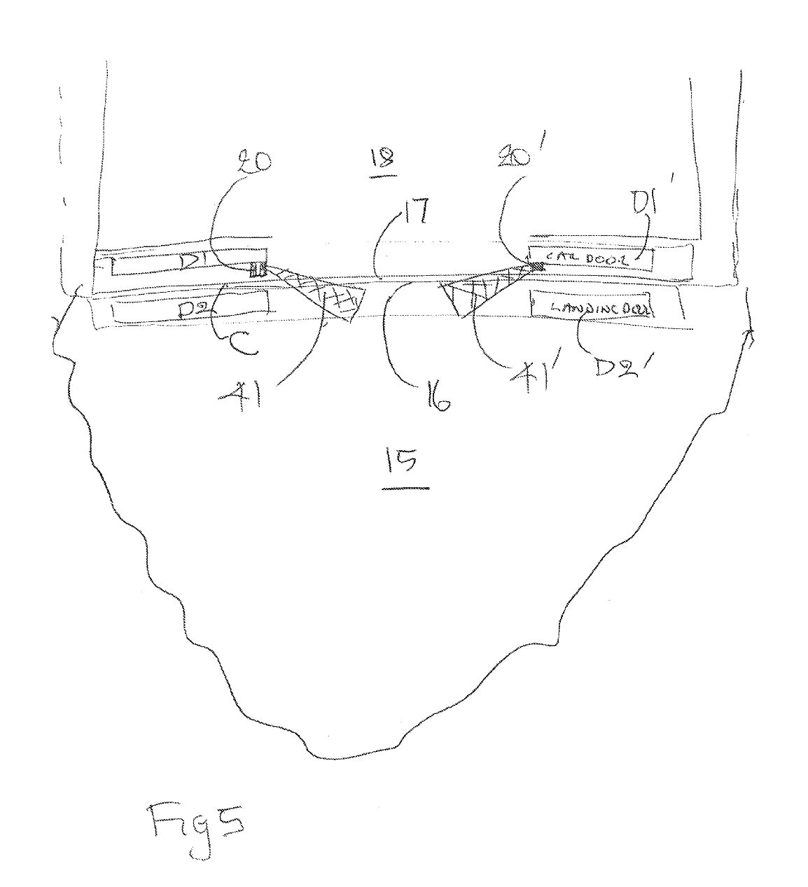

FIG. 5 is a partial plan view of the lift installation of FIGS. 2 to 4.

### Second Embodiment

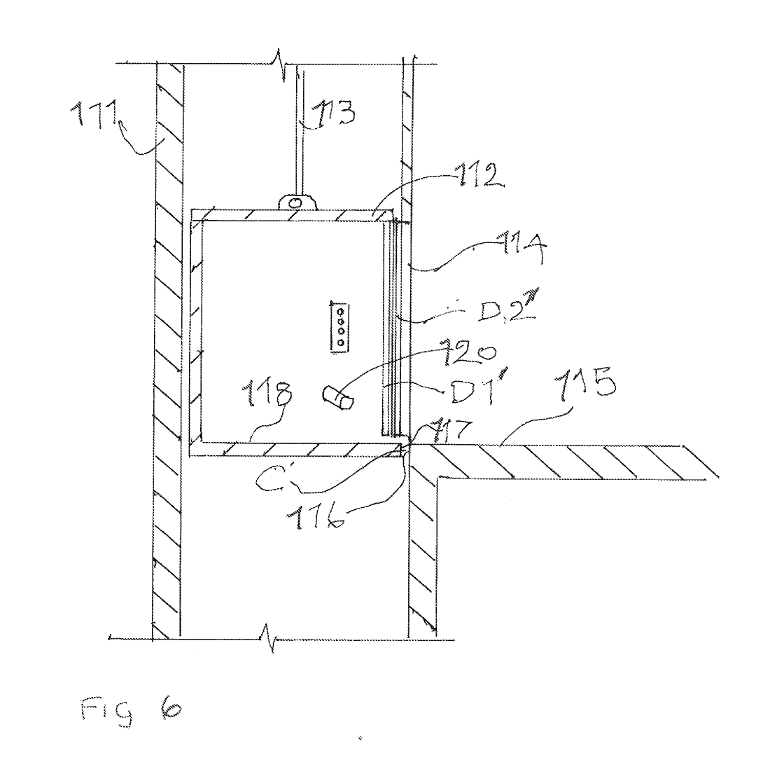

FIG. 6 is a side elevation of a lift installation similar in many respects to that of FIG. 3;

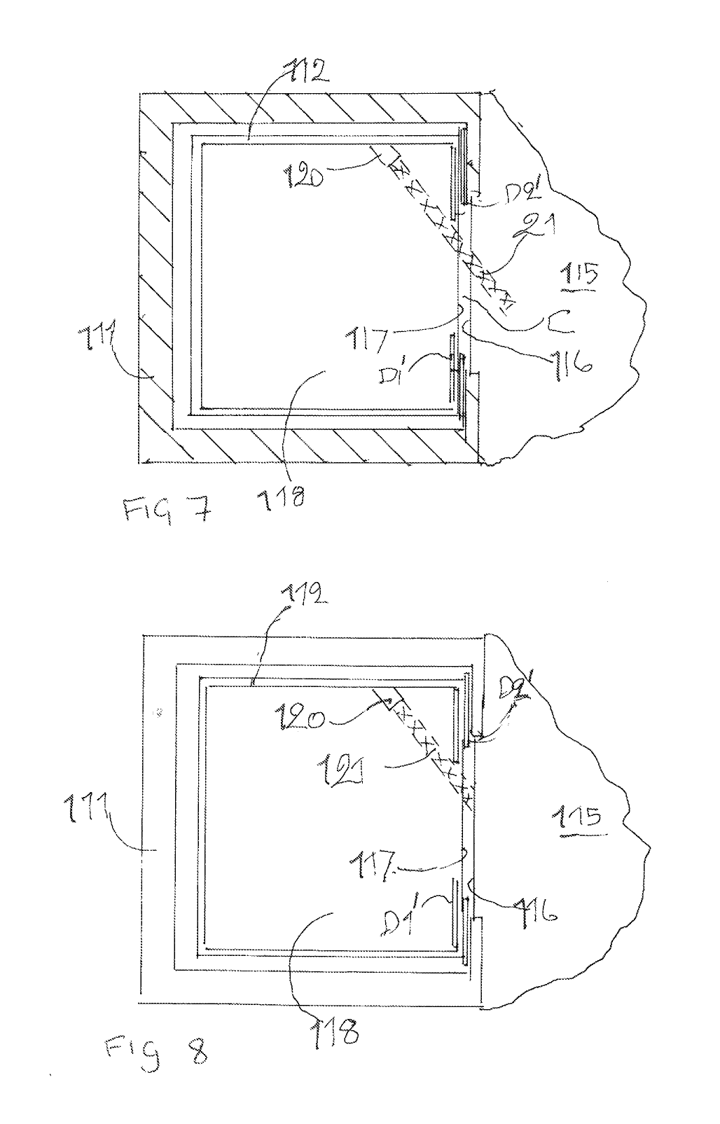

FIG. 7 is a plan view of the installation of FIG. 6 with components in a first position; and

FIG. 8 is a plan view of the installation of FIG. 6 with components in a second configuration.

### MODE FOR CARRYING OUT THE INVENTION

FIGS. 1 to 5 are of a first embodiment of the invention and variously show a part of an elevator installation with components in different positions. A given component is identified by the same reference in all figures in which it appears.

Elevator shaft 11 contains an elevator car 12 suspended by means of a cable 13.

The elevator shaft 11 is provided with a sequence of shaft openings, one for each floor (of which only opening 14 is shown) at which the elevator car 12 can be positioned to allow users into and out of the car 12. In this case the opening 14 has doors D2, D2′ through which access can be had to car 12 through its doors D1, D1′.

At the opening 14 the outside floor 15 has a working edge 16 intended for alignment with front edge 17 of car floor 18 so that outside floor 15 and car floor 18 lie in the same plane as shown in FIG. 3 with a working clearance C between them.

The car 12 is raised and lowered by a cable 13 powered by a hoist (not shown) and which is governed by means of a control system which provides for the positioning of the front edge 17 relative to working edge 16 with car floor 18 co-planar with outside floor 15. However it is not unknown for the control system to function in such a way that the floor 15 and the car floor 18 do not lie in the same plane but have a degree of offset P as shown in FIG. 4. In FIG. 4 the car 12 is shown stopped with the front edge of 17 of lift floor 18 lying above the working edge 16 of floor 15 by the amount P which is outside the acceptable control tolerance. In an alternative faulty juxtaposition these relative positions could be reversed with the front edge 17 of the car floor 18 lying below the working edge 16.

As shown in FIG. 4 the off-set P of car floor 18 and floor 15 could result in a user on leaving the car 12 to stumble outwardly or one entering the car to trip over the raised edge of the car floor 18.

FIG. 5 shows the doors D1 and D1′ of the car 12 with light projectors, respectively projectors 20, 20′, mounted at their lower end 40 and each positioned to direct a beam of light 41, 41′outwardly from the car 12 across the outer part of car floor 18 over the clearance C and across to the outside floor 15. Given that the car floor 18 is co-planar with the outside floor 15 then the beams 41, 41′ will, as shown in FIG. 5, appear as a continuous beam extending over the working gap. In this situation there is no step change which could lead to tripping or falling.

If the car floor 18 is not co-planar with the outside floor 15 then the light beams 41, 41′ will not appear as continuous.

In the event the car floor 18 is below the level of the outside floor 15 then the light beams 41, 41′will be limited in length by being stopped by the upward step formed by the front edge 16 of the floor 15 lying above the front edge of the car floor 18. This gives rise to a substantial change in the visual appearance of the projected beams 41, 41′relative to the neighbouring floor areas so providing a warning to people leaving the car 12 that egress could be hazardous.

In the event the car floor 18 is above the level of the outside floor 15 then the beams 41, 41′ will either vanish on reaching the intersection C or will re-appear on the outside floor 15 at some distance from the car entry. Either occurrence results in a substantial change in the visual appearance of the beams 41, 41′ and the neighbouring floor areas so providing a warning to people leaving the car 12 that egress could be hazarded by stumbling.

FIGS. 6 to 8 show a second embodiment of the present invention. An elevator shaft 111 contains an elevator car 112 suspended by means of a cable 113.

The elevator shaft 111 is provided with a sequence of openings, one for each floor, of which only opening 114 is shown at which the elevator car 112 can be positioned to allow users into and out of the car 112. In this case the opening 114 provides for access to and from landing floor 115 through the open door D1′ located within the elevator car 112 and open door D2′ located permanently at the opening 14. At the opening 114 the floor 115 has a working edge 116 intended for alignment with front edge 117 of lift floor 118 so that floor 115 and elevator floor 118 lie in the same plane as shown in FIG. 6 with a working clearance C′ between them . The car 112 houses a light projector 120 located just above lift floor 118 and adapted, with the lift floor 118 and outside floor 115 lying in the same plane, to provide for a parallel sided light pattern 121 to be projected along the working edge 116, front edge 117 and working clearance C′ as will be described hereafter in connection with FIGS. 7 and 8.

The cable 113 is caused to raise the car 112 by means of a motor (not shown) having a control system providing for the raising and lowering of the car 112 and for the positioning of the front edge 117 relative to working edge 116 with lift floor 118 co-planar with floor 115. However as previously mentioned it is not unknown for the control system to function in such a way that the floor 115 and the elevator floor 118 do not lie in the same plane but have a degree of offset.

FIG. 7 shows the elevator car 118 level with the stage floor 115 and with the light projector 120 directing a light beam pattern 121 across the front edge 117, working edge 116 and clearance C′. The pattern 121 is coherent along its length since the front edge 17 and working edge 16 lie in a common horizontal plane within the working tolerance of the car control system. Entry to, and egress from, the car can be undertaken without fear of tripping or falling caused by a serious level difference.

FIG. 8 shows the lift configuration with the lift floor 115 at a lower level than the stage floor 115 with the light projector 120 directing light beam pattern 122 as before across the front edge 117, working edge 116 and clearance C′. In this case the pattern 121 is disrupted, when compared with the pattern 121 of FIG. 7, since the lift floor 118 and outside floor 15 no longer lie in the same plane. The disruption serves to indicate that their relative positions of edges 116, 117 are outside the working tolerance of the car control system. As a consequence the disrupted light pattern 121 provides clear visual evidence that a level difference exists.

The warning device of the present invention is particularly intended to inform people leaving the car that egress is safe as far as level is concerned or that a difference in level exists. Such information could also useful to people approaching the car to enter it if they aware of the significance of the light beam. In the event that it is continuous across car floor and outside floor then the level configuration is safe. In the event the beam is interrupted then caution needs to be exercised.

### INDUSTRIAL APPLICABILITY

The present invention provides a safety device providing for drawing the attention of users of an elevator car by highlighting when the car floor is not coplanar with a floor to which the elevator provides access.

What is claimed is:

1. A method of hazard highlighting for drawing visual attention to the alignment of first and second members, the first member having a first plane working surface and a first working edge; the second member having a second plane working surface and a second working edge; the first and second working edges being separated by a working clearance; the first and second members being displaceable relative to one another wherein, in a first operating configuration, the first and second plane working surfaces lie in a common plane with the first and second working edges juxtaposed with the working clearances separated by a minimum distance; and, in a second configuration, the first and second plane working surfaces do not lie in the common plane and the first and second working edges are displaced from one another to a greater or lesser degree with the working edges being separated by a distance greater than minimum; the method including the step of projecting a light ray or pattern from a location associated with the first working surface towards the second working surface and across the working clearance so that to an observer situated above the first and second working surfaces and in the first configuration the projected light ray or pattern appears as a continuous image extending across both working surfaces; and in the second configuration the projected light ray or pattern becomes an image visually interrupted in the vicinity of the working clearance by comparison with the continuous image of the first configuration.

2. A method of hazard highlighting as claimed in claim 1 wherein the first member is a floor of an elevator car and the second member is a floor outside the elevator car to enable people and/or goods to pass between the elevator car and the floor outside the elevator car; with the first and second members in their second configuration with a difference in level between the floor of the elevator car and the floor outside the elevator car a warning signal is generated, at least for a passenger in the elevator, as to the significance of the differences between the continuous and discontinuous images.

3. An apparatus for drawing visual attention to the alignment of first and second members, the first member having a first plane working surface and a first working edge; the second member having a second plane working surface and a second working edge; the first and second working edges being separated by a working clearance; the first and second members being displaceable relative to one another wherein, in a first operating configuration, the first and second plane working surfaces lie in a common plane with the first and second working edges juxtaposed with the working clearances separated by a minimum distance; and, in a second configuration, the first and second plane working surfaces do not lie in the common plane and the first and second working edges are displaced from one another to a greater or lesser degree with the working edges being separated by a distance greater than minimum characterized by at least one light ray or pattern projecting means located by way of the first member and relative to the first working surface whereby the or each means causes a light ray or pattern to be projected towards the second working surface by way of the working clearance so that with the members in their first configuration the projected light ray or pattern appears as a continuous image extending across both the first and second working surfaces; and in the second configuration the projected light ray or pattern becomes an image visually interrupted in the vicinity of the working clearance by comparison with the continuous image.

4. An apparatus according to claim 3 in which relative movement of members is vertical.

5. An elevator car equipped with the apparatus as claimed in claims 3.

6. An elevator car as claimed in claim 5 wherein the first member is separated from the second by a slidable barrier operable between an open position where the barrier enables the passage of people or items from the first working surface to the second and a closed position where the barrier serves to prevent such passage characterized in that the or at least one light projecting means is incorporated in the slidable barrier to provide for the or each projected light ray or pattern to be projected as aforesaid at least with the barrier in the open position.

7. An elevator car as claimed in claim 5 wherein the first member is separated from the second by a slidable barrier operable between an open position where the barrier enables the passage of people or items from the first working surface to the second and a closed position where the barrier serves to prevent such passage characterised in that the or at least one light projecting means is incorporated within the car to provide for the or each projected light ray or pattern to be projected across the car and through the region left open with the barrier in the open position.

8. An elevator car equipped with the apparatus as claimed in claim 4.

9. An elevator car as claimed in claim 8 wherein the first member is separated from the second by a slidable barrier operable between an open position where the barrier enables the passage of people or items from the first working surface to the second and a closed position where the barrier serves to prevent such passage characterized in that the or at least one light projecting means is incorporated in the slidable barrier to provide for the or each projected light ray or pattern to be projected as aforesaid at least with the barrier in the open position.

10. An elevator car as claimed in claim 8 wherein the first member is separated from the second by a slidable barrier operable between an open position where the barrier enables the passage of people or items from the first working surface to the second and a closed position where the barrier serves to prevent such passage characterised in that the or at least one light projecting means is incorporated within the car to provide for the or each projected light ray or pattern to be projected across the car and through the region left open with the barrier in the open position.
